(19) United States
(12) Patent Application Publication
(10) Pub. No.: US 2016/0112112 A1
(43) Pub. Date: Apr. 21, 2016

(54) METHOD AND APPARATUS FOR BEAMFORMING

(71) Applicant: Electronics and Telecommunications Research Institute, Daejeon (KR)

(72) Inventors: Juyul LEE, Daejeon (KR); Myung-Don KIM, Daejeon (KR); Jinup KIM, Daejeon (KR)

(73) Assignee: Electronics and Telecommunications Research Institute, Daejeon (KR)

(21) Appl. No.: 14/681,212

(22) Filed: Apr. 8, 2015

(30) Foreign Application Priority Data
Oct. 20, 2014 (KR) 10-2014-0142034

(51) Int. Cl. H04B 7/08; H04W 40/06; H04L 5/00

(52) U.S. Cl. CPC H04B 7/0834; H04L 5/0069; H04W 40/06; H04W 88/02

(57) ABSTRACT

An apparatus for beamforming of a terminal acquires sensing information from an internal sensor, confirms whether the terminal is positioned in a street canyon of a road, and if it is confirmed that the terminal is positioned in the street canyon of a road, uses the sensing information to form beams of each antenna.

### CROSS-REFERENCE TO RELATED APPLICATION

This application claims priority to and the benefit of Korean Patent Application No. 10-2014-0142034 filed in the Korean Intellectual Property Office on Oct. 20, 2014, the entire contents of which are incorporated herein by reference.

### BACKGROUND OF THE INVENTION

1. Field of the Invention

The present invention relates to a method and an apparatus for beamforming, and more particularly, to a method and an apparatus for beamforming of a multiple antenna transceiver using one or more sensors of a mobile terminal.

2. Description of the Related Art

A beamforming technology may be used in transmitting and receiving directions of a communication system using a multiple antenna, and beamforming in a receiver is called beam combining in the related art.

In most mobile communication systems, a receiver estimates a channel and feeds back the estimated channel to a transmitter. The transmitter uses the feedback channel information to determine a beamforming vector, thereby forming a beam of an antenna.

Recently, for the purpose of public safety and the like at the time of dispersion and disaster with a corresponding sudden increase of mobile communication traffic, research into device-to-device (D2D), peer-to-peer (P2P), vehicle-to-vehicle (V2V), and machine-to-machine (M2M) schemes has been conducted and some of them have been launched as services. Direct communication between such terminals is not a scheme of performing communication through a base station but is a scheme of performing communication through a direct channel between the terminals

Compared with the communication using the base station, in the direct communication between the terminals, it is more difficult to configure the feedback channel. Therefore, a method for forming a beam of an antenna without feedback channel information from a receiver to a transmitter is required.

The above information disclosed in this Background section is only for enhancement of understanding of the background of the invention and therefore it may contain information that does not form the prior art that is already known in this country to a person of ordinary skill in the art.

### SUMMARY OF THE INVENTION

The present invention has been made in an effort to provide a method and an apparatus for beamforming capable of forming a beam of an antenna without feedback information from a receiver to a transmitter.

An exemplary embodiment of the present invention provides a method for beamforming of a terminal using a multiple antenna. The method for beamforming includes: acquiring sensing information from at least one internal sensor of the terminal; confirming whether the terminal is positioned in a street canyon of a road; and forming beams of each antenna using the sensing information if it is confirmed that the terminal is positioned in the street canyon of the road.

The beamforming may include calculating beamforming coefficients of each antenna using the sensing information.

The calculating of the beamforming coefficients of each antenna may include: extracting a positional state of the terminal based on a progress direction of the terminal using the sensing information; and calculating the beamforming coefficients of each antenna so that the beams are formed along one direction of the road based on the positional state of the terminal.

The calculating of the beamforming coefficients of each antenna may further include correcting the beamforming coefficients of each antenna based on radio wave strength received in the progress direction and radio wave strength received in an opposite direction to the progress direction.

The correcting may include determining the beamforming coefficients of each antenna so that the beam is formed only in the progress direction or the opposite direction, when a difference between the radio wave strength received in the progress direction and the radio wave strength received in the opposite direction to the progress direction is equal to or more than a threshold value.

The determining may include determining the beamforming coefficients of each antenna so that the beam is formed only in a direction in which the radio wave strength is larger.

The confirming may include: acquiring latitude and longitude coordinates from information of a GPS, a wireless local area network (WLAN), or a base station; and determining whether the terminal is positioned in the street canyon of the road using map data from the latitude and longitude coordinates.

The confirming may include: confirming whether the terminal moves in a constant direction using the sensing information acquired from an acceleration sensor and a compass; confirming whether the received radio wave strength is monotonically increased or monotonically decreased, when the terminal moves in a constant direction; and determining whether the terminal is positioned in the street canyon of the road when the received radio wave strength is monotonically increased or monotonically decreased.

The at least one internal sensor may include at least one of a gyro sensor, an acceleration sensor, a gravity sensor, a compass, and a GPS receiver.

Another embodiment of the present invention provides an apparatus for beamforming of a terminal using a multiple antenna. The apparatus for beamforming includes a sensing information acquirer, a position extractor, a beamforming coefficient calculator, and a beamformer. The sensing information acquirer may acquire a plurality of sensing information from at least one internal sensor. The position extractor may confirm whether the terminal is positioned in a street canyon of a road using at least one first sensing information of the plurality of sensing information. The beamforming coefficient calculator may calculate beamforming coefficients of each antenna for beamforming using the sensing information when the terminal is positioned in the street canyon of the road. The beamformer may form beams based on the beamforming coefficients of each antenna.

The position extractor may extract a positional state of the terminal based on a progress direction of the terminal using at least one sensing information of the plurality of sensing information, and the beamforming coefficient calculator may calculate the beamforming coefficients of each antenna so that the beam is formed along one direction of the road based on the positional state of the terminal.

The beamforming coefficient calculator may correct the beamforming coefficients of each antenna based on radio wave strength of a progress direction and radio wave strength in an opposite direction to the progress direction.

The beamforming coefficient calculator may correct the beamforming coefficients of each antenna so that the beam is formed only in a direction having a larger radio wave strength of radio wave strengths in the progress direction and the opposite direction when a difference between the radio wave strengths in the progress direction and the opposite direction is equal to or more than a predetermined threshold value.

The position extractor may determine whether the terminal is positioned in the street canyon of the road using map data from latitude and longitude coordinates acquired from information of a GPS, a wireless local area network (WLAN), or a base station.

The position extractor may determine whether the terminal is positioned in a street canyon of the road based on a motion direction of the terminal and the received radio wave strength.

### BRIEF DESCRIPTION OF THE DRAWINGS

FIG. 1 is a diagram illustrating a concept of direct communication between terminals to which an exemplary embodiment of the present invention is applied.

FIG. 2 is a diagram schematically illustrating beamforming of a receiver.

FIG. 3 is a diagram schematically illustrating a method for beamforming of a transmitter.

FIG. 4 is a diagram illustrating a propagation path in a street grid environment of a downtown area.

FIG. 5 is a diagram illustrating a measurement moving path of a power azimuth spectrum (PAS) of a radio wave.

FIG. 6 is a diagram illustrating a case in which the PAS of the radio wave is measured on a road.

FIG. 7 is a flowchart illustrating the method for beamforming according to the exemplary embodiment of the present invention.

FIG. 8 is a flowchart illustrating an example of a method for positioning a terminal according to the exemplary embodiment of the present invention.

FIG. 9 is a diagram illustrating an example in which a terminal is positioned on a road.

FIG. 10 is a flowchart illustrating the method for calculating a beamforming coefficient according to the exemplary embodiment of the present invention.

FIGS. 11 and 12 are diagrams illustrating an example of a method for correcting, by a transmitter, beamforming coefficients of each antenna according to an exemplary embodiment of the present invention.

FIG. 13 is a diagram illustrating an apparatus for beamforming according to an exemplary embodiment of the present invention.

### DETAILED DESCRIPTION OF THE EMBODIMENTS

In the following detailed description, only certain exemplary embodiments of the present invention have been shown and described, simply by way of illustration. As those skilled in the art would realize, the described embodiments may be modified in various different ways, all without departing from the spirit or scope of the present invention. Accordingly, the drawings and description are to be regarded as illustrative in nature and not restrictive. Like reference numerals designate like elements throughout the specification.

Throughout the present specification and claims, unless explicitly described to the contrary, “comprising” any components will be understood to imply the inclusion of other elements rather than the exclusion of any other elements.

Throughout the specification, a terminal may be called user equipment (UE), a mobile terminal (MT), a mobile station (MS), an advanced mobile station (AMS), a high reliability mobile station (HR-MS), a subscriber station (SS), a portable subscriber station (PSS), an access terminal (AT), and the like, and may also include functions of all or some of the terminal, the UE, the MT, the MS, the AMS, the HR-MS, the SS, the PSS, the AT, and the like.

Further, a base station (BS) may be named a node B, an evolved node B (eNB), an advanced base station (ABS), a high reliability base station (HR-BS), an access point (AP), a radio access station (RAS), a base transceiver station (BTS), and the like, and may also include all or a part of the node B, the eNB, the ABS, the HR-BS, the AP, the RAS, and the BTS, and the like.

Hereinafter, a method and an apparatus for beamforming according to an exemplary embodiment of the present invention will be described in detail with reference to the accompanying drawings.

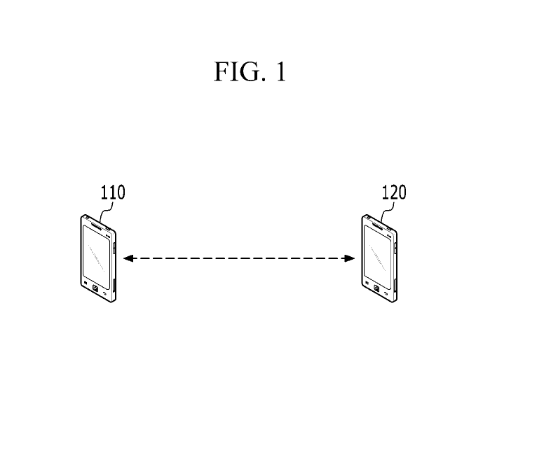

FIG. 1 is a diagram illustrating a concept of direct communication between terminals to which an exemplary embodiment of the present invention is applied.

Referring to FIG. 1, a terminal 110 transmits to and receives from a terminal 120 adjacent thereto without passing through a base station (not illustrated). The terminals 110 and 120 directly communicate with each other through a channel. The communication scheme is called direct communication between terminals.

The terminals 110 and 120 may include a multiple transmitting/receiving antenna. The terminals 110 and 120 may be a receiver and a transmitter.

The terminals 110 and 120 form a beam corresponding to each antenna. In this case, since the direct communication between the terminals may not easily configure a feedback channel, the terminals 110 and 120 use various internal sensors of the terminal without feedback information to form beams of each antenna. An example of the internal sensor may include a gyro sensor, an acceleration/gravity sensor for motion information, a compass for orientation, a GPS receiver, and the like, to obtain a positional state of the terminals 110 and 120.

The beamforming may be used in transmitting and receiving directions of a communication system using a multiple transmitting/receiving antenna, and beamforming in a receiver is called beam combining in the related art.

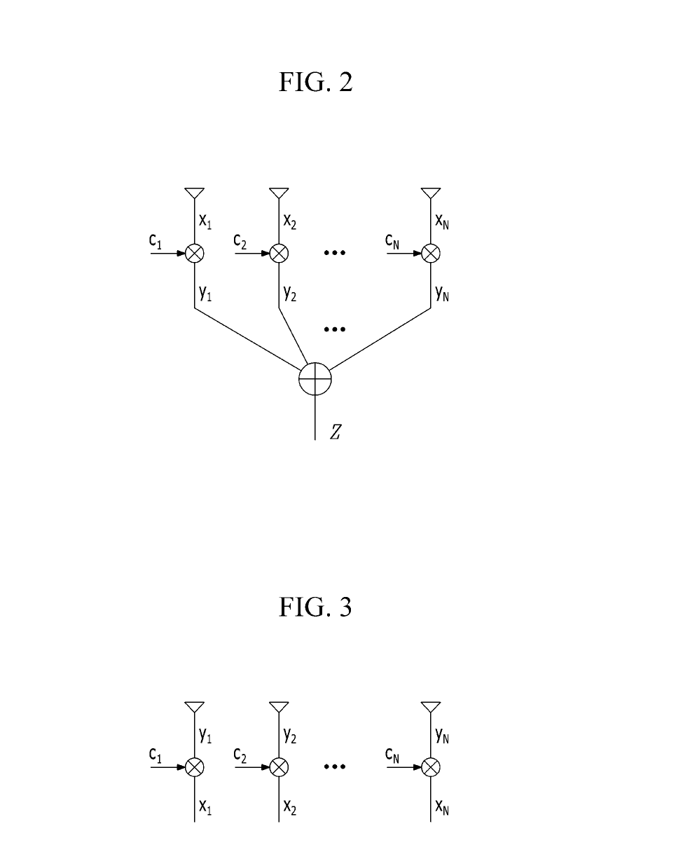

FIG. 2 is a diagram schematically illustrating beamforming of a receiver.

Referring to FIG. 2, the receiver uses a multiple receiving antenna and obtains a finally received signal by multiplying beamforming coefficients by received signals of each receiving antenna.

For example, in the case in which the number of receiving antennas is N, when the received signals of each receiving antenna are set to be x₁, x₂, . . . , x_{N} and the beamforming coefficients of each receiving antenna are set to be c₁, c₂, . . . , c_{N}, the received signals of each receiving antenna depends on the following Equation 1.

yₙ=cₙxₙ, n=1, . . . , N (Equation 1)

The received signals of each receiving antenna are summed as the following Equation 2 and thus the finally received signal is obtained.

$$z = {\sum }_{n = 1}^{N} {y}_{n} = {\sum }_{n = 1}^{N} {c}_{n} {x}_{n} \qquad ( Equation 2 )$$

FIG. 3 is a diagram schematically illustrating a method for beamforming of a transmitter.

Referring to FIG. 3, the transmitter uses a multiple transmitting antenna and obtains finally transmitted signals of each antenna by multiplying beamforming coefficients by transmitted signals of each transmitting antenna.

For example, in the case in which the number of transmitting antennas is N, when the transmitted signals of each transmitting antenna are set to be x₁, x₂, . . . , x_{N} and the beamforming coefficients of each transmitting antenna are set to be c₁, c₂, . . . , c_{N}, the finally transmitted signals of each transmitting antenna may be represented by the following Equation 3.

yₙ=cₙxₙ, n=1, . . . , N (Equation 3)

As such, the transmitter and the receiver have the same structure, and therefore only the beamforming of the transmitter will be described below.

First, the most significant feature of the direct communication between the terminals is that a height of the transmitting and receiving antenna is low. In particular, when the direction communication between the terminals is used for a dispersion of traffic capacity, and the like, it is expected that the direction communication between the terminals is very frequently used in congested areas of most downtown areas.

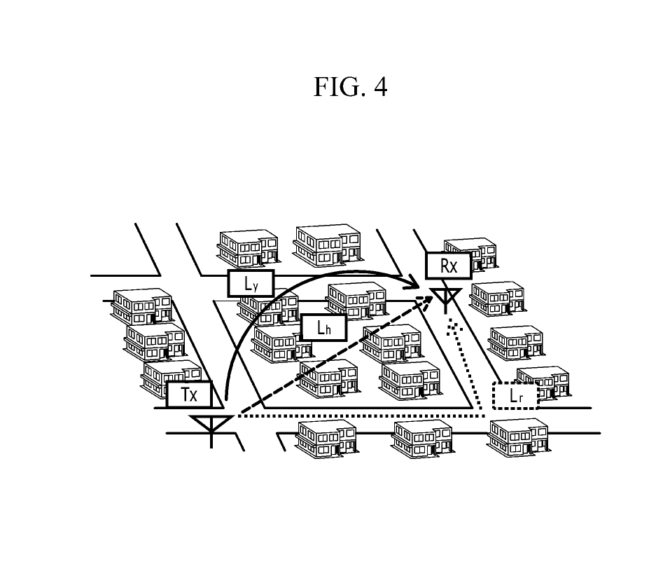

FIG. 4 is a diagram illustrating a propagation path in a street grid environment of a downtown area.

Referring to FIG. 4, when antennas of a transmitter and a receiver (Tx and Rx) are positioned low in a street grid environment of downtown areas, a radio wave is propagated along a road. That is, the fact that a propagation path Lᵣ which is propagated along a road among various propagation paths L_{y}, Lₕ, and Lᵣ between the transmitter and the receiver Tx and Rx is dominant is verified by a paper entitled “Path loss model with low antenna height for microwave bands in residential areas,”.

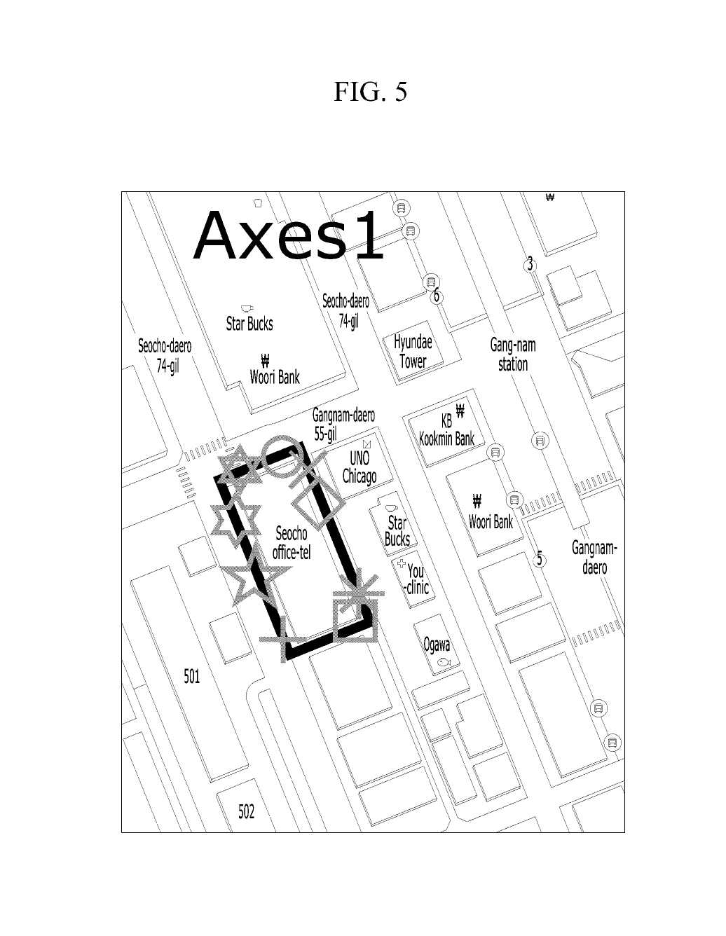

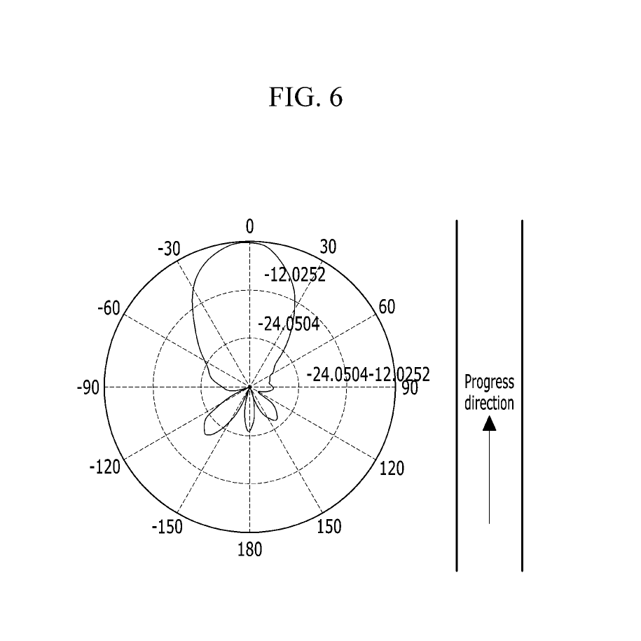

FIG. 5 is a diagram illustrating a measurement moving path of a power azimuth spectrum (PAS) of a radio wave, and FIG. 6 is a diagram illustrating a case in which the PAS of the radio wave is measured on a road.

FIG. 5 illustrates the measurement of the PAS of the radio wave while the terminal having the multiple antenna moves along roads around Gangnam Station in Seoul, and as illustrated in FIG. 5, it may be appreciated that the measurement moving path of the PAS of the radio wave is progressed along a road.

In particular, referring to FIG. 6, 0° means a progress direction of the receiver, and therefore it may be appreciated that the PAS of the radio wave may be concentrated on the progress direction of the road.

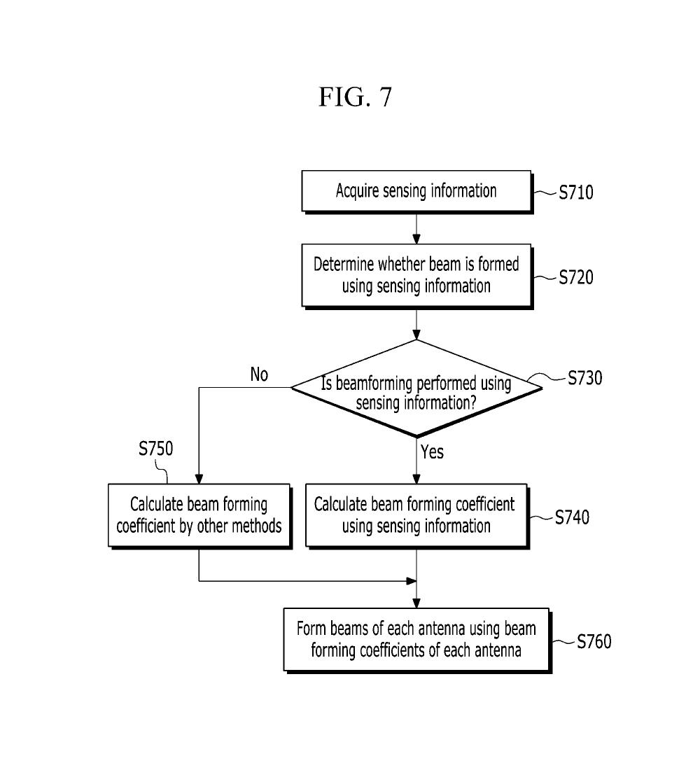

FIG. 7 is a flowchart illustrating the method for beamforming according to the exemplary embodiment of the present invention.

Referring to FIG. 7, the transmitter acquires the sensing information from the internal sensor (S710). The transmitter may be a portion of the terminal.

The transmitter determines whether the beam is formed using the sensing information acquired from the internal sensor (S720).

If the transmitter determines that the beam is formed using the sensing information (S730), the transmitter calculates the beamforming coefficients of each antenna for beamforming using the sensing information (S740).

The beamforming using the sensing information starts under the assumption that the transmitter (i.e., the terminal) is positioned in a street canyon of a road and thus a radio wave is progressed along a road. Therefore, the transmitter uses the sensing information acquired through the internal sensor to confirm whether the transmitter is positioned in a street canyon of a current road. There are various methods for confirming whether the transmitter is positioned in the street canyon of the current road. Here, as the most direct method, the transmitter may determine a position of the transmitter using map data from latitude and longitude coordinates acquired from information of a GPS of the transmitter, a wireless local area network (WLAN), or a base station. As an indirect method, there are methods using an acceleration sensor and a compass of the transmitter together with the received radio wave strength. If it is determined that the transmitter is positioned in the street canyon of the current road, it may be determined that the transmitter performs the beamforming using the sensing information.

Meanwhile, if it is determined that the transmitter does not perform the beamforming using the sensing information, the beamforming coefficients of each antenna are calculated by other methods (S750). As an example of other methods, the transmitter receives the channel information from the receiver and may calculate the beamforming coefficients of each antenna using the received channel information.

The transmitter uses the beamforming coefficients of each antenna to form beams of each antenna (S760) and sends out the beams of each antenna. That is, the transmitter may form the beams of each antenna by multiplying the beamforming coefficients of each antenna by transmitting signals of each antenna.

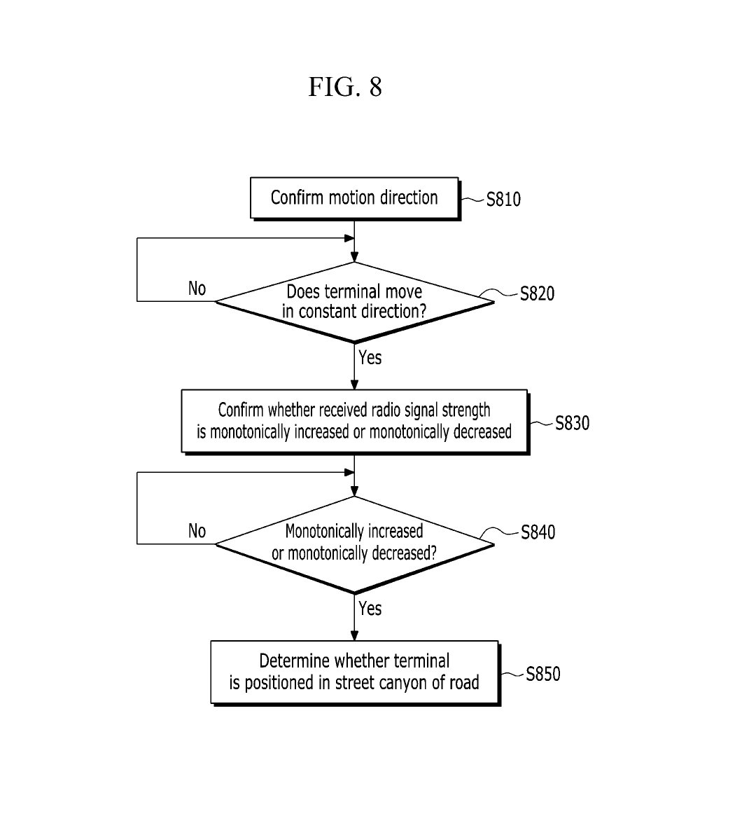

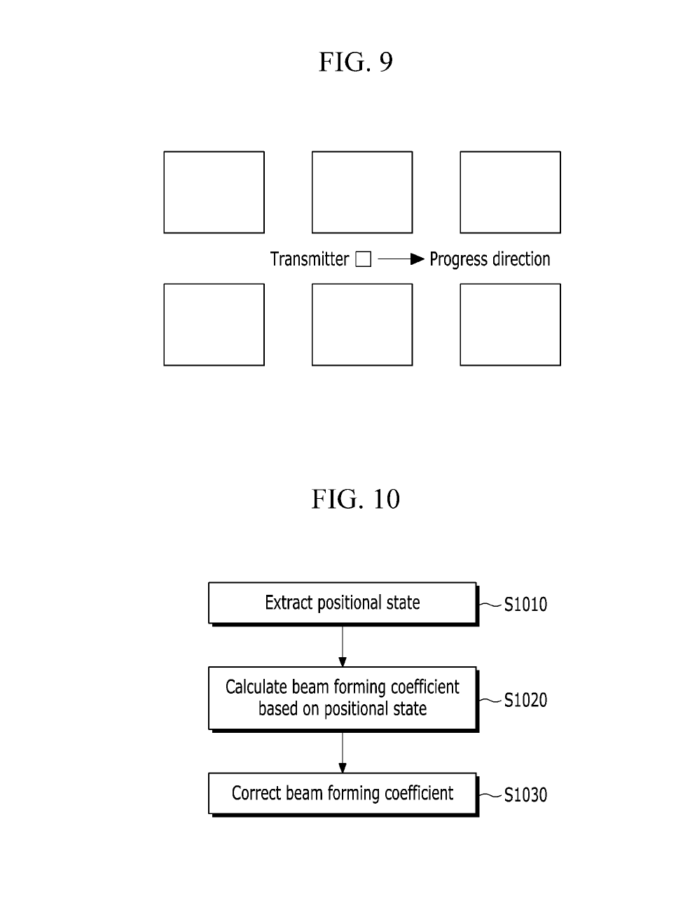

FIG. 8 is a flowchart illustrating an example of a method for positioning a terminal according to the exemplary embodiment of the present invention, and FIG. 9 is a diagram illustrating an example in which a terminal is positioned on a road.

Referring to FIG. 8, to determine whether the beam is formed using the sensing information, the transmitter confirms whether the terminal is positioned in the street canyon of the road. To this end, the transmitter confirms a motion direction of the transmitter using sensing information acquired from the acceleration sensor and the compass (S810). That is, the transmitter of the terminal confirms whether the terminal moves in a constant direction, for example, in a straight direction.

As the confirmation result that the transmitter of the terminal confirms the motion direction of the terminal, if it is confirmed that the terminal moves in the constant direction (S820), it is confirmed whether the received radio wave strength is monotonically increased or monotonically decreased (S830).

If it is confirmed that the received radio wave strength is monotonically increased or monotonically decreased (S840), the transmitter determines that the terminal is positioned in the street canyon of the road (S850).

When the transmitter moves from the street grid to the direction as illustrated in FIG. 9, the transmitter of the terminal may confirm that the terminal moves in the straight direction using the sensing information acquired from the acceleration sensor and the compass. Further, since the radio wave is progressed along a road, the radio wave strength is monotonically increased or monotonically decreased. Therefore, it may be understood whether the terminal is positioned in the street canyon of the road using the motion direction of the terminal and the radio wave strength.

FIG. 10 is a flowchart illustrating the method for calculating a beamforming coefficient according to the exemplary embodiment of the present invention.

Referring to FIG. 10, the transmitter uses the sensing information acquired from the internal sensor to extract a positional state of the transmitter based on a progress direction (S1010). The transmitter may use the gyro sensor, the compass, and the like to extract the positional state based on the progress direction on the road.

The transmitter calculates the beamforming coefficients of each antenna so that the beam is formed along one direction of the road based on the positional state (S1020). One direction may be a progress direction on a road, and may be an opposite direction to the progress direction on the road. As such, when the beam is formed along one direction of the road, the beam is reflected from or absorbed into a building, and the like, such that an attenuated amount of the beam may be reduced. For example, when the positional state of the terminal rotates as much as 8 based on the progress direction of the terminal, a desired angle for beamforming becomes 8. In this case, the beamforming coefficients of each antenna may be calculated as the following Equation 4.

c₁=1, c₂=e^{-jkd cosθ}, . . . , c_{N}=e^{-j(N-1)kd cosθ} (Equation 4)

In the above Equation 4, k represents a wave number depending on frequency and d is a distance between the antennas. In this case, the beamforming coefficients may be multiplied by any constant.

Next, the transmitter may correct the beamforming coefficients of each antenna based on the received radio wave strength (S1030). In the street grid, the radio wave may be received in the opposite direction to the progress direction of the transmitter. The transmitter calculates a difference between the radio wave strength in the progress direction on the road and the radio wave strength in the opposite direction, and if it is determined that the difference between the radio wave strengths is equal to or more than a predetermined threshold value, corrects the beamforming coefficients of each antenna so that the beam is formed only in any one of the progress direction and the opposite direction.

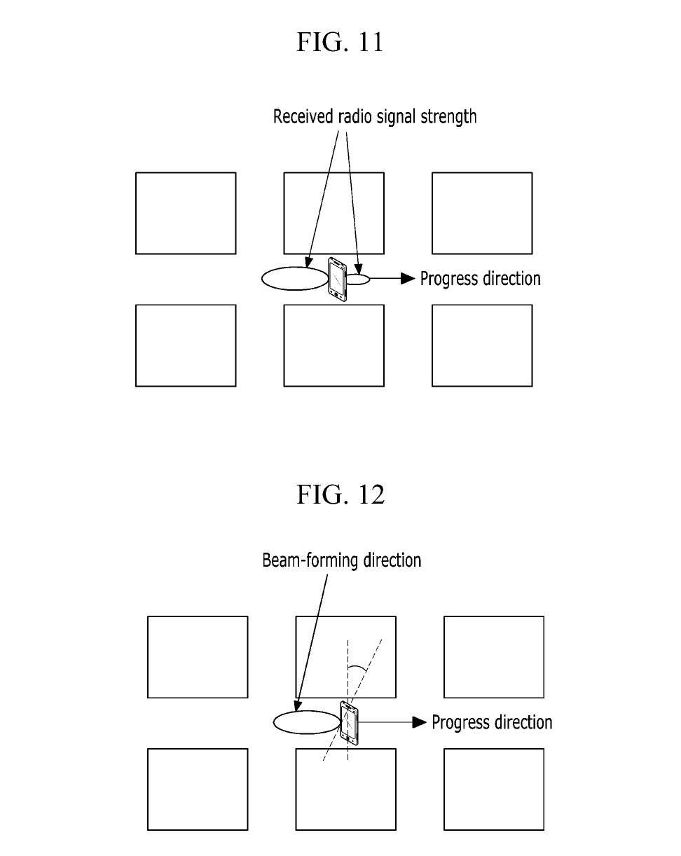

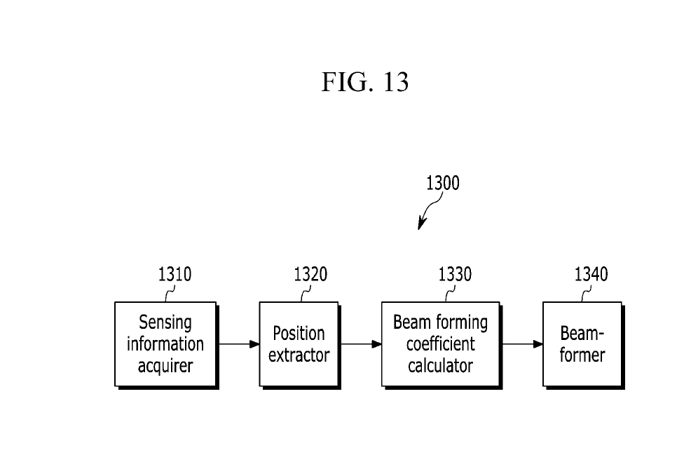

FIGS. 11 and 12 are diagrams illustrating an example of a method for correcting, by a transmitter, beamforming coefficients of each antenna according to an exemplary embodiment of the present invention.

As illustrated in FIG. 11, the radio wave strength received in the progress direction of the terminal from the transmitter may be small and the radio wave strength received in the opposite direction to the progress direction may be large. In this case, the receiver is positioned in the opposite direction to the progress direction of the terminal, and therefore as illustrated in FIG. 12, the transmitter of the terminal corrects the beamforming coefficients of each antenna so that the beam is formed in the opposite direction to the progress direction of the terminal. By doing so, receiving sensitivity of the receiver may be increased.

FIG. 13 is a diagram illustrating an apparatus for beamforming according to an exemplary embodiment of the present invention.

Referring to FIG. 13, a beamforming apparatus 1300 includes a sensing information acquirer 1310, a position extractor 1320, a beamforming coefficient determiner 1330, and a beamformer 1340. The beamforming apparatus 1300 may be implemented in the terminal.

The sensing information acquirer 1310 acquires the sensing information from the internal sensor of the terminal.

The position extractor 1320 uses the sensing information to confirm whether the terminal is positioned in the street canyon of the road, and if it is confirmed that the terminal is positioned in the street canyon of the road, extracts the positional state of the terminal based on the progress direction of the terminal.

The beamforming coefficient determiner 1330 calculates the beamforming coefficient for beamforming so that the beam is formed along one direction on the road based on the progress direction of the terminal and the positional state of the terminal. If it is determined that the difference between the radio wave strength in the progress direction and the radio wave strength in the opposite direction is equal to or more than a predetermined threshold value, the beamforming coefficient determiner 1330 may adjust the beamforming coefficients so that the beam is formed only in any one of the progress direction and the opposite direction.

The beamformer 1340 multiplies the beamforming coefficients of each antenna by the transmitting signals of each antenna to form the beams of each antenna and send out the beams of each antenna.

At least some functions of the method and apparatus for beamforming according to the exemplary embodiment of the present invention as described above may be implemented by hardware or software coupled with the hardware. For example, processors, such as a central processing unit (CPU), other chipsets, and a microprocessor, may perform functions of the sensing information acquirer 1310, the position extractor 1320, the beamforming coefficient determiner 1330, and the beamformer 1340, and a transceiver may perform a transmission and reception function to and from other terminals.

According to an exemplary embodiment of the present invention, the beamforming may be provided through the internal sensor of the terminal according to geographical features of a downtown area. As a result, it is possible to simplify the feedback channel for providing the channel information. Further, since the feedback channel is not required, there is no need to transmit a pilot tone for channel estimation at the transmitting terminal, and it is possible to increase efficiency of the data transfer rate.

The exemplary embodiments of the present invention are not implemented only by the apparatus and/or method as described above, but may be implemented by programs realizing the functions corresponding to the configuration of the exemplary embodiments of the present invention or a recording medium recorded with the programs, which may be readily implemented by a person having ordinary skill in the art to which the present invention pertains from the description of the foregoing exemplary embodiments.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

What is claimed is:

1. A method for beamforming of a terminal using a multiple antenna, comprising:
acquiring sensing information from at least one internal sensor of the terminal;
confirming whether the terminal is positioned in a street canyon of a road; and
forming beams of each antenna using the sensing information if it is confirmed that the terminal is positioned in the street canyon of the road.

2. The method of claim 1, wherein the beamforming includes calculating beamforming coefficients of each antenna using the sensing information.

3. The method of claim 2, wherein the calculating of the beamforming coefficients of each antenna includes:
extracting a positional state of the terminal based on a progress direction of the terminal using the sensing information; and
calculating the beamforming coefficients of each antenna so that the beams are formed along one direction of the road based on the positional state of the terminal.

4. The method of claim 2, wherein the calculating of the beamforming coefficients of each antenna further includes correcting the beamforming coefficients of each antenna based on radio wave strength received in the progress direction and radio wave strength received in an opposite direction to the progress direction.

5. The method of claim 4, wherein the correcting includes determining the beamforming coefficients of each antenna so that the beam is formed only in the progress direction or the opposite direction, when a difference between the radio wave strength received in the progress direction and the radio wave strength received in the opposite direction to the progress direction is equal to or more than a threshold value.

6. The method of claim 5, wherein the determining includes determining the beamforming coefficients of each antenna so that the beam is formed only in a direction in which the radio wave strength is larger.

7. The method of claim 1, wherein the confirming includes:
acquiring latitude and longitude coordinates from information of a GPS, a wireless local area network (WLAN), or a base station; and
determining whether the terminal is positioned in the street canyon of the road using map data from the latitude and longitude coordinates.

8. The method of claim 1, wherein the confirming includes:
confirming whether the terminal moves in a constant direction using the sensing information acquired from an acceleration sensor and a compass;
confirming whether the received radio wave strength is monotonically increased or monotonically decreased, when the terminal moves in a constant direction; and
determining whether the terminal is positioned in the street canyon of the road when the received radio wave strength is monotonically increased or monotonically decreased.

9. The method of claim 1, wherein the at least one internal sensor includes at least one of a gyro sensor, an acceleration sensor, a gravity sensor, a compass, and a GPS receiver.

10. An apparatus for beamforming of a terminal using a multiple antenna, comprising:
a sensing information acquirer acquiring a plurality of sensing information from at least one internal sensor;
a position extractor confirming whether the terminal is positioned in a street canyon of a road using at least one first sensing information of the plurality of sensing information;
a beamforming coefficient calculator calculating beamforming coefficients of each antenna for beamforming using the sensing information when the terminal is positioned in the street canyon of the road; and
a beamformer forming beams based on the beamforming coefficients of each antenna.

11. The apparatus of claim 10, wherein the position extractor extracts a positional state of the terminal based on a progress direction of the terminal using at least one second sensing information of the plurality of sensing information, and the beamforming coefficient calculator calculates the beamforming coefficients of each antenna so that the beam is formed along one direction of the road based on the positional state of the terminal.

12. The apparatus of claim 10, wherein the beamforming coefficient calculator corrects the beamforming coefficients of each antenna based on radio wave strength of a progress direction and radio wave strength in an opposite direction to the progress direction.

13. The apparatus of claim 12, wherein the beamforming coefficient calculator corrects the beamforming coefficients of each antenna so that the beam is formed only in a direction having a larger radio wave strength of radio wave strengths in the progress direction and the opposite direction when a difference between the radio wave strengths in the progress direction and the opposite direction is equal to or more than a predetermined threshold value.

14. The apparatus of claim 10, wherein the position extractor determines whether the terminal is positioned in a street canyon of the road using map data from latitude and longitude coordinates acquired from information of a GPS, a wireless local area network (WLAN), or a base station.

15. The apparatus of claim 10, wherein the position extractor determines whether the terminal is positioned in the street canyon of the road based on a motion direction of the terminal and the received radio wave strength.

16. The apparatus of claim 10, wherein the at least one internal sensor includes at least one of a gyro sensor, an acceleration sensor, a gravity sensor, a compass, and a GPS receiver.
